(19) United States
(12) Patent Application Publication
(10) Pub. No.: US 2026/0299224 A1
(43) Pub. Date: Oct. 1, 2026

(54) OPTICAL ELEMENT ASSEMBLY, METHOD FOR MANUFACTURING OPTICAL ELEMENT ASSEMBLY, OPTICAL MODULE, OPTICAL ENGINE, AND XR GLASSES

(71) Applicant: TDK CORPORATION, Tokyo (JP)

(72) Inventors: Takashi HONDA, Tokyo (JP); Ryohei FUKUZAKI, Hong Kong (CN); Tsuyoshi KOMAKI, Tokyo (JP)

(73) Assignee: TDK CORPORATION, Tokyo (JP)

(21) Appl. No.: 19/575,145

(22) Filed: Mar. 23, 2026

(30) Foreign Application Priority Data
Mar. 31, 2025 (JP) 2025-057741

(51) Int. Cl. G02B 6/42; G02B 27/01

(52) U.S. Cl. CPC G02B 6/4228; G02B 6/4245; G02B 27/0172

(57) ABSTRACT

This optical element assembly includes a laser diode, and an optical waveguide layer including an optical waveguide guiding laser light output from the laser diode. The optical waveguide layer has an alignment marker. The alignment marker is provided on an outermost surface of the optical waveguide layer and is positioned on an inner side of an outer peripheral edge of the optical waveguide layer.

### BACKGROUND OF THE INVENTION

### Field of the Invention

The present disclosure relates to an optical element assembly, a method for manufacturing an optical element assembly, an optical module, an optical engine, and XR glasses.

The present application claims priority on Japanese Patent Application No. 2025-057741 filed on Mar. 31, 2025, the content of which is incorporated herein by reference.

### Description of Related Art

Optical element assemblies for XR glasses, such as augmented reality (AR) glasses and virtual reality (VR) glasses incorporating a plurality of laser diodes, are expected to serve as compact wearable devices. In wearable devices such as AR glasses and VR glasses, miniaturization such that all functions fit within an ordinary eyeglass form factor is the key to widespread adoption.

As for an optical element assembly, a configuration is known in which a light emitting assembly including light emitting elements formed therein and an optical waveguide assembly including optical waveguides formed therein are bonded (for example, Patent Document 1). In order to axially align positions of active layers of the light emitting elements with the optical waveguides, Patent Document 1 has a configuration in which projections are provided in a light emitting element assembly, and grooves for fitting the projections of the light emitting element assembly are provided on the optical waveguide assembly.

The optical element assembly of Patent Document 1 is configured such that the active layers and the optical waveguides are axially aligned when the projections of the light emitting element assembly are fitted into the grooves of the optical waveguide assembly.

### Patent Document

[Patent Document 1] Japanese Unexamined Patent Application, First Publication No. 2003-329898

### SUMMARY OF THE INVENTION

However, in the optical element assembly of the foregoing Patent Document 1, positional alignment is achieved through the structural design of the two members. Nevertheless, such structural design of the projections and the grooves has limitations in coping with recent miniaturization of optical element assemblies, and there is a demand for other methods capable of positionally aligning light emitting elements and waveguides. In addition, it is also devised to provide an alignment marker on a surface on which a waveguide exit of an optical element assembly is positioned. However, when an alignment marker is provided on the surface on which the waveguide exit is positioned, since an optical waveguide layer provided with an optical waveguide is miniaturized along with the miniaturization of the optical element assembly, it is necessary to reduce the size of the alignment marker. However, if the size of the alignment marker is reduced, it becomes difficult to find the alignment marker when observed from an exit surface side of the optical waveguides, and thus there is a limitation in coping with miniaturization.

The present disclosure is an invention made in consideration of the foregoing circumstances, and an object thereof is to provide an optical element assembly which is positionally aligned with high accuracy even when elements are miniaturized; a method for manufacturing an optical element assembly which can be positionally aligned with high accuracy even for miniaturized elements; and an optical module, an optical engine, and XR glasses, each including the optical element assembly.

In order to solve the foregoing problems, the present disclosure provides the following features.
[1] An optical element assembly according to an aspect of the present disclosure includes a laser diode, and an optical waveguide layer including an optical waveguide guiding laser light output from the laser diode. The optical waveguide layer has an alignment marker. The alignment marker is provided on an outermost surface of the optical waveguide layer and is positioned on an inner side of an outer peripheral edge of the optical waveguide layer.
[2] In the optical element assembly according to [1], the alignment marker may be a metal film.
[3] In the optical element assembly according to [2], the metal film may be an Au film or a Ta film.
[4] In the optical element assembly according to [1], the alignment marker may be a recessed portion.
[5] In the optical element assembly according to any one of [1] to [4], a line width of the alignment marker may be 20μm or more.
[6] In the optical element assembly according to any one of [1] to [5], in a plan view, the alignment marker may have an L-shape. Each side constituting the L-shape may be parallel to any one of an input surface, an output surface, and a side surface of the optical waveguide layer.
[7] The optical element assembly according to any one of [1] to [6] may further include a base mount including the laser diode mounted on a main surface thereof, an optical waveguide substrate including the optical waveguide layer provided on a main surface thereof, and a plurality of metal films bonding the base mount and the optical waveguide substrate.
[8] The optical element assembly according to [7] may further include a plurality of the laser diodes. The base mount may be constituted of a plurality of base mounts. The laser diodes may be respectively mounted on the plurality of base mounts.
[9] In the optical element assembly according to [7] or [8], the optical waveguide substrate may be an Si substrate. A core of the optical waveguide layer may be composed of SiO₂.
[10] In the optical element assembly according to [7] or [8], the optical waveguide substrate may be an SiO₂ substrate. A core of the optical waveguide layer may be composed of SiN.
[11] In the optical element assembly according to [7] or [8], the optical waveguide substrate may be a sapphire substrate. A core of the optical waveguide layer may be formed of LiNbO₃.
[12] An optical module according to another aspect of the present disclosure includes the optical element assembly according to any one of [1] to (11), and a package. The optical element assembly is accommodated inside the package.
[13] An optical engine according to another aspect of the present disclosure includes the optical module according to, and an optical scanning mirror reflecting light output from the optical module while changing an angle so as to display an image.
[14] XR glasses according to another aspect of the present disclosure include the optical engine according to mounted thereon.
[15] A method for manufacturing an optical element assembly according to another aspect of the present disclosure includes a bonding step of bonding a laser diode assembly to an optical waveguide chip. The laser diode assembly includes a base mount, and a laser diode mounted on a main surface of the base mount. The optical waveguide chip includes an optical waveguide substrate, and an optical waveguide layer provided on a main surface of the optical waveguide substrate and having an alignment marker. The alignment marker is provided on an outermost surface of the optical waveguide layer and is positioned on an inner side of an outer peripheral edge of the optical waveguide layer. In the bonding step, the optical waveguide layer is observed in a plan view to identify an input port of a core of the optical waveguide layer and positionally align the laser diode assembly using coordinates of the alignment marker, and the laser diode assembly is bonded to the optical waveguide chip in a state where the laser diode assembly is positionally aligned.
[16] In the method for manufacturing an optical element assembly according to, the laser diode assembly may be positionally aligned such that a center of the input port of the core of the optical waveguide layer coincides with an optical axis of laser light output from the laser diode.
[17] In the method for manufacturing an optical element assembly according to or, after positional alignment using the coordinates of the alignment marker, laser light may be irradiated from the laser diode, and a position of the laser diode assembly may be finely adjusted while checking an intensity of the laser light from an output port of the optical waveguide layer.
[18] The method for manufacturing an optical element assembly according to any one of to may further include a dicing step and an alignment marker forming step prior to the bonding step. In the dicing step, a plurality of the optical waveguide chips may be formed by dicing a substrate provided with a plurality of the optical waveguide layers. In the alignment marker forming step, an alignment marker may be formed on the optical waveguide layer of each of the plurality of the optical waveguide chips.
[19] The method for manufacturing an optical element assembly according to any one of two may further include a bar cutting-out step and an alignment marker forming step prior to the bonding step, and a dicing step after the bonding step. In the bar cutting-out step, an optical waveguide bar member including a plurality of the optical waveguide chips may be cut out from a substrate provided with a plurality of the optical waveguide layers. In the alignment marker forming step, an alignment marker may be formed on each of one or more of the optical waveguide layers of the optical waveguide bar member. In the bonding step, the optical waveguide layers may be observed in a plan view to identify any one input port of the optical waveguide layers and positionally align the laser diode assembly using coordinates of the alignment marker, the laser diode assembly may be bonded to the optical waveguide bar member in a state where the laser diode assembly is positionally aligned, and this operation may be performed for all of the plurality of the optical waveguide layers. In the dicing step, the optical waveguide bar member including a plurality of the laser diode assemblies bonded thereto may be diced.
[20] In the method for manufacturing an optical element assembly according to or, in the alignment marker forming step, a thin film made of gold or tantalum may be formed on the optical waveguide layer.

According to the present disclosure, it is possible to provide: an optical element assembly which is positionally aligned with high accuracy even when elements are miniaturized; a method for manufacturing an optical element assembly which can be positionally aligned with high accuracy even for miniaturized elements; and an optical module, an optical engine, and XR glasses, each including the optical element assembly.

### BRIEF DESCRIPTION OF THE DRAWINGS

FIG. 1 is a perspective view showing an example of a configuration of an optical element assembly according to one embodiment of the present disclosure.

FIG. 2 is a plan view of the optical element assembly in FIG. 1.

FIG. 3 is a cross-sectional view of the optical element assembly shown in FIG. 1 taken along line A-A’.

FIG. 4A is a perspective view of a plurality of laser diode assemblies in FIG. 1.

FIG. 4B is a perspective view of an optical waveguide substrate in FIG. 1.

FIG. 5A is a cross-sectional view showing a modification example of a structure of the optical waveguide substrate and an optical waveguide layer on which an alignment marker that can be used in the optical element assembly according to one embodiment of the present disclosure is formed.

FIG. 5B is a cross-sectional view showing another modification example of a structure of the optical waveguide substrate and the optical waveguide layer on which the alignment marker that can be used in the optical element assembly according to one embodiment of the present disclosure is formed.

FIG. 6A is a plan view showing an example of an optical waveguide chip that can be used in a method for manufacturing an optical element assembly according to one embodiment of the present disclosure.

FIG. 6B is a view of an example of the optical waveguide chip that can be used in the method for manufacturing an optical element assembly according to one embodiment of the present disclosure, as observed from a lateral side.

FIG. 7 is an explanatory schematic view of a configuration of the method for manufacturing an optical element assembly according to one embodiment of the present disclosure, and is a perspective view showing a state of a bonding step.

FIG. 8 is another explanatory schematic view of the configuration of the method for manufacturing an optical element assembly according to one embodiment of the present disclosure, and is a cross-sectional view showing a state of the bonding step.

FIG. 9A is a view showing a modification example of the method for manufacturing an optical element assembly according to one embodiment of the present disclosure.

FIG. 9B is a view showing another modification example of the method for manufacturing an optical element assembly according to one embodiment of the present disclosure.

FIG. 10 is a plan view showing an example of a configuration of an optical module according to one embodiment of the present disclosure.

FIG. 11 is a cross-sectional view of the optical module in FIG. 10.

FIG. 12 is an explanatory plan view of a configuration inside a package of the optical module in FIG. 10.

FIG. 13 is a schematic plan view of the configuration in FIG. 12 as viewed from an output surface.

FIG. 14 is an explanatory conceptual view of XR glasses according to one embodiment of the present disclosure.

FIG. 15 is a conceptual view showing a state where an image is directly projected onto a retina by laser light output from the optical module according to one embodiment of the present disclosure.

### DETAILED DESCRIPTION OF THE INVENTION

Hereinafter, an embodiment will be described in detail with reference to the drawings as appropriate. In the drawings used in the following description, in order to facilitate understanding of the characteristics, characteristic parts may be shown in an enlarged manner for convenience, and dimensional ratios or the like of each constituent element may differ from actual values. Materials, dimensions, and the like exemplified in the following description are merely examples. The present disclosure is not limited thereto and can be suitably modified and carried out within a range in which the effects of the present disclosure are exhibited.

### Optical element Assembly

An optical element assembly according to one embodiment of the present disclosure includes a laser diode, and an optical waveguide layer including an optical waveguide guiding laser light output from the laser diode. The optical waveguide layer has an alignment marker. The alignment marker is provided on an outermost surface of the optical waveguide layer and is positioned on an inner side of an outer peripheral edge of the optical waveguide layer.

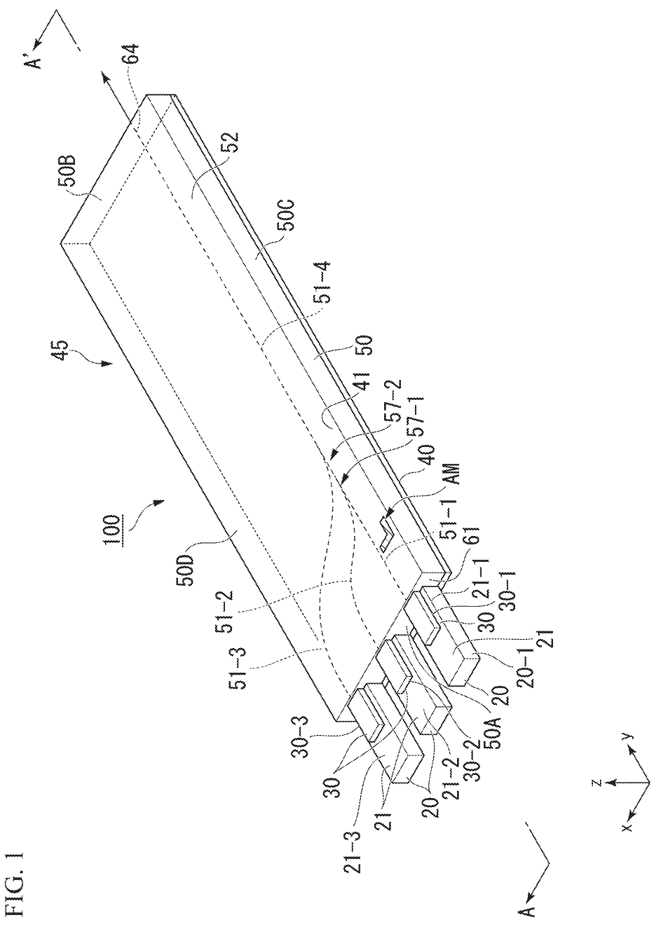

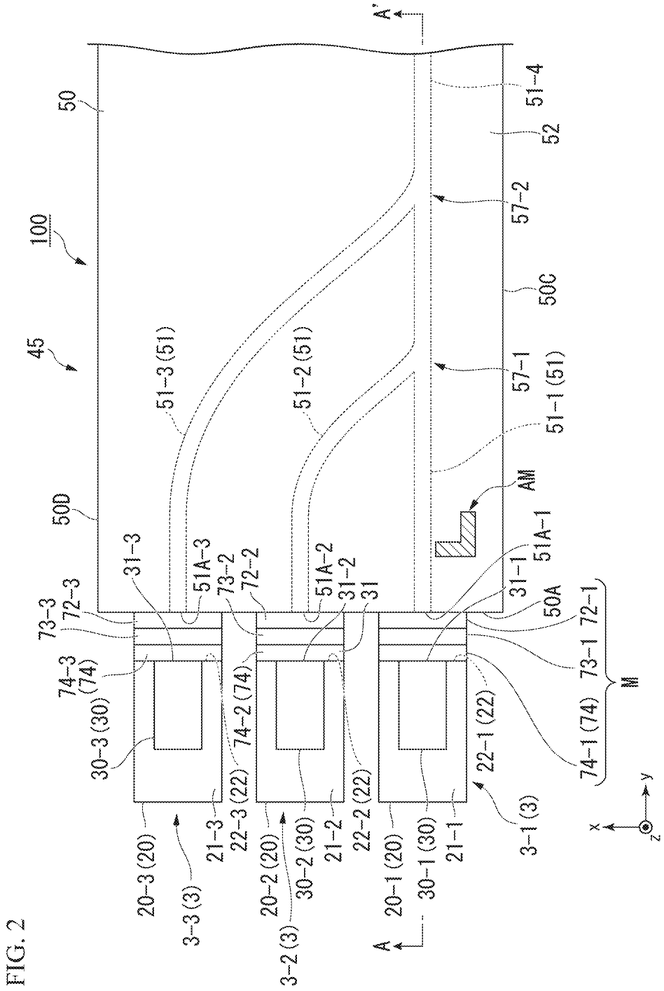

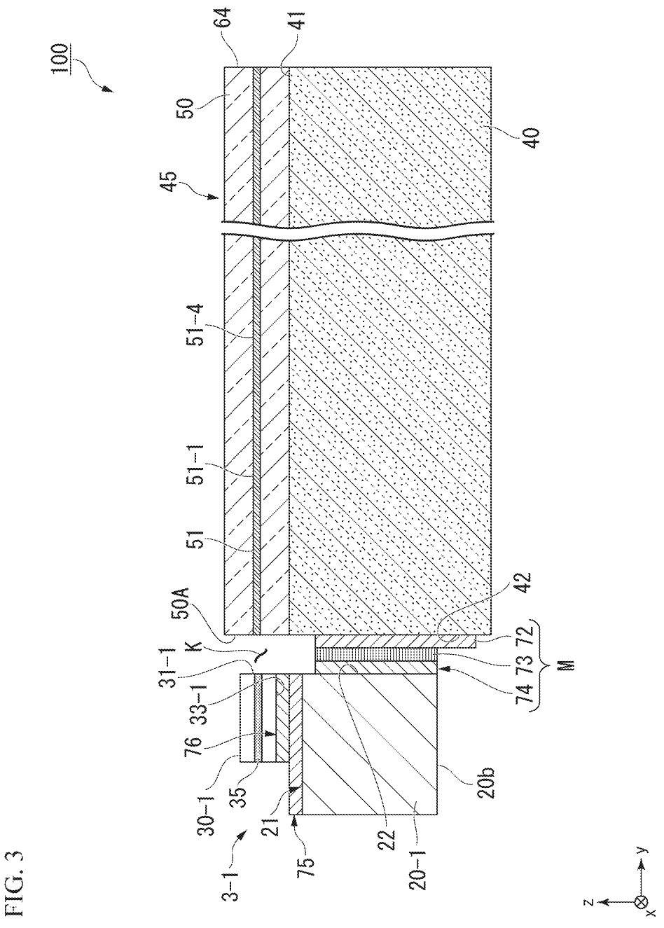

FIG. 1 is a perspective view showing an example of a configuration of an optical element assembly according to one embodiment of the present disclosure. FIG. 2 is a plan view of the optical element assembly in FIG. 1. FIG. 3 is a cross-sectional view of the optical element assembly shown in FIG. 1 taken along line A-A’.

For example, the optical element assembly shown in FIGS. 1 - 3 includes a plurality of laser diode assemblies 3 (3-1, 3-2, 3-3) serving as laser diodes, and an optical waveguide substrate 40 in which an optical waveguide layer 50 including optical waveguides 51 guiding laser light output from the plurality of laser diode assemblies 3 are provided on a main surface thereof. FIGS. 1 - 3 show an example in which three laser diode assemblies are formed, but the present disclosure is not limited to this example.

In the present embodiment, when features different from those of members denoted by reference signs X-1, X-2, and X-3 are described for a member denoted by the reference sign X, the members are distinguished and described using the reference signs X-1, X-2, and X-3, respectively. Features common to these members are described collectively using only the reference sign X. In addition, in the present embodiment, a base mount 20 may also be referred to as a subcarrier. In addition, a laser diode 30 may also be referred to as a laser diode.

An optical element assembly 100 shown in FIG. 1 includes: three laser diodes 30; three base mounts 20 (20-1, 20-2, 20-3) on which the three respective laser diodes 30 are mounted on main surfaces 21-1, 21-2, and 21-3 and which are arranged apart from each other; the optical waveguide layer 50 which includes at least optical waveguides 51 guiding laser light output from the three laser diodes 30 (30-1, 30-2, 30-3); the optical waveguide substrate 40 on which the optical waveguide layer 50 is provided on a main surface thereof; and metal films M which bond the base mounts 20 (20-1, 20-2, 20-3) and the optical waveguide substrate 40. The metal films M (72, 73, 74) are arranged between base mount-side bonding surfaces 22 (22-1, 22-2, 22-3) of the respective base mounts 20 (20-1, 20-2, 20-3) and a plurality of substrate-side bonding portions 42-1, 42-2, and 42-3 which are provided on a bonding surface 42 of the optical waveguide substrate 40, corresponding to the respective base mount-side bonding surfaces 22-1, 22-2, and 22-3, and are arranged apart from each other, thereby bonding the base mounts 20-1, 20-2, and 20-3 and the optical waveguide substrate 40.

### Laser Diode and Laser Diode Base Mount

In the optical element assembly 100 shown in FIG. 1, the laser diodes 30-1, 30-2, and 30-3 are respectively a laser diode emitting red light, a laser diode emitting green light, and a laser diode emitting blue light. For example, the laser diodes 30-1, 30-2, and 30-3 are bare chips (unpackaged chips) and can be individually mounted on the three respective base mounts 20-1, 20-2, and 20-3.

For example, the subcarriers (base mounts) 20-1, 20-2, and 20-3 are composed of aluminum nitride (AlN), silicon (Si), or the like.

In the present embodiment, the laser diode assemblies 3 (3-1, 3-2, 3-3) respectively include the base mounts 20-1, 20-2, and 20-3, and the laser diodes 30-1, 30-2, and 30-3 mounted on the main surfaces 21-1, 21-2, and 21-3 of the base mounts 20-1, 20-2, and 20-3.

First metal layers 75 and second metal layers 76 are provided between the subcarriers 20 and the laser diodes 30 (refer to FIG. 3). The subcarriers 20 and the laser diodes 30 are connected with the first metal layers 75 and the second metal layers 76 therebetween. As for a method for forming the first metal layers 75 and the second metal layers 76, a known method can be utilized without any particular limitations, and a known technique such as sputtering, vapor deposition, or application of a metal paste can be utilized. For example, the first metal layers 75 and the second metal layers 76 may contain one or a plurality of metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiIn, and PbBiIn, or may consist of one or a plurality of metals selected from this group.

### Optical Waveguide Layer and Optical Waveguide Substrate

As shown in FIGS. 1 - 3, the optical waveguide layer 50 is formed on the optical waveguide substrate 40.

In the present embodiment, a structure in which the optical waveguide layer 50 is laminated on the optical waveguide substrate 40 may be referred to as an optical waveguide chip 45. Specifically, the optical waveguide chip 45 includes the optical waveguide substrate 40, and the optical waveguide layer 50 provided on a main surface (upper surface) 41 of the optical waveguide substrate 40.

Examples of the optical waveguide substrate 40 include a sapphire substrate, an Si substrate, and a thermally oxidized silicon substrate. When the optical waveguides of the optical waveguide layer 50 are formed of a lithium niobate (LiNbO₃) film, the material of the optical waveguide substrate 40 is not particularly limited as long as it has a lower refractive index than the lithium niobate film. However, it is preferable to use a sapphire single-crystal substrate or a silicon single-crystal substrate as a substrate on which a single-crystal lithium niobate film can be formed as an epitaxial film. A crystal orientation of the single-crystal substrate is not particularly limited. For example, since a c-axis-oriented lithium niobate film has threefold symmetry, it is desirable that the single-crystal substrate (base) also has the same symmetry. Therefore, a c-plane substrate is preferable in the case of a sapphire single-crystal substrate, and a (111)-plane substrate is preferable in the case of a silicon single-crystal substrate.

The optical waveguide layer 50 includes at least the optical waveguides guiding laser light output from the laser diodes. This optical waveguide layer is not particularly limited, and for example, a known configuration can be employed. Examples of the optical waveguide layer will be described below.

The optical waveguide layer 50 is a layer referred to as a planar lightwave circuit (PLC). In addition, optical waveguides 51-1, 51-2, and 51-3 may also be referred to as cores 51-1, 51-2, and 51-3.

The optical waveguide layer 50 is defined by an input surface 50A positioned on the laser diode assembly 3 side, an output surface 50B facing the input surface 50A, and side surfaces 50C and 50D connecting the input surface 50A and the output surface 50B. In the present embodiment, the input surface 50A, the output surface 50B, and the side surfaces 50C and 50D may collectively be referred to as the outer peripheral edge. The optical element assembly 100 according to the present embodiment has an alignment marker AM positioned on the outermost surface of the optical waveguide layer 50 and on the inner side of the outer peripheral edge of the optical waveguide layer 50. Here, “the inner side of the outer peripheral edge of the optical waveguide layer 50” means that the alignment marker AM does not come into contact with any of the input surface 50A, the output surface 50B, and the side surfaces 50C and 50D. The alignment marker AM is provided apart from the input surface 50A, the output surface 50B, and the side surfaces 50C and 50D by 50μm or more, for example.

As described above, since the alignment marker AM is provided on the outermost surface of the optical waveguide layer 50, its size can be increased as compared with a case where it is formed on the output surface 50B or the input surface 50A, for which there is a high demand for miniaturization, even when the optical element assembly 100 is miniaturized. The alignment marker AM is provided on an outer side in a width direction from any of the cores 51-1 to 51-3 formed in the optical waveguide layer 50 and on the input surface 50A side from a merging position 57-1. More specifically, an example is described in which an end portion of the alignment marker AM on the output surface 50B side is positioned on the input surface 50A side from a midpoint between the input surface 50A and the merging position 57-1.

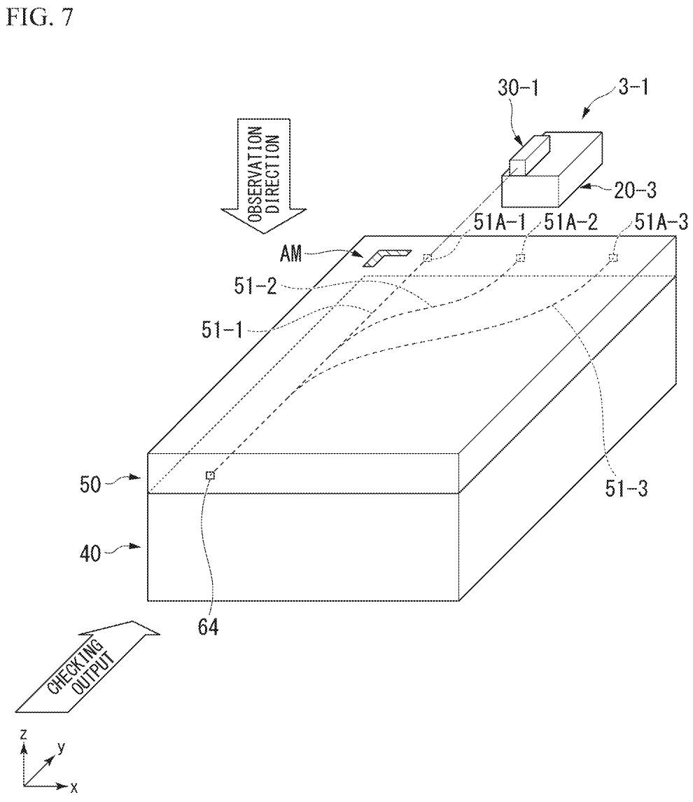

The accurate distances between the alignment marker AM and input ports 51A-1, 51A-2, and 51A-3 of the respective cores 51-1, 51-2, and 51-3 in any of an x direction, a y direction, and a z direction are ascertained. The optical waveguide layer 50 is observed in a plan view to identify the coordinate position (positional information) of the alignment marker AM, making it possible to identify the coordinate positions of the input ports 51A-1, 51A-2, and 51A-3. Observing the optical waveguide layer 50 in a plan view to identify the coordinate positions of the alignment marker AM includes a configuration in which the optical waveguide layer is viewed in a plan view while the optical waveguide layer 50 is also observed in other directions at the same time, as will be described below in detail using FIG. 7.

From the viewpoint of ease of detection, it is preferable that a pattern width (line width) of the area of the alignment marker AM when the optical waveguide layer 50 is viewed in a plan view be 20μm or more. The shape of the alignment marker AM can be arbitrarily set. FIGS. 1 and 2 show an L-shaped structure constituted of a rectangle extending in the x direction in which the plurality of laser diode assemblies 3 are arranged and a rectangle extending in the y direction from the input surface 50A toward the output surface 50B. That is, all sides constituting the alignment marker AM shown in FIGS. 1 and 2 are parallel to any of the input surface 50A, the output surface 50B, and the side surfaces 50C and 50D. With such a structure, the alignment marker AM can be easily detected, the relative positional relationship with the cores 51-1, 51-2, and 51-3 can be easily detected. In this manner, it is preferable that the alignment marker AM be constituted of sides parallel to any of the input surface 50A, the output surface 50B, and the side surfaces 50C and 50D.

For example, the alignment marker AM is a metal film. The metal film may be any metal film that is resistant to oxidation. The metal film is more preferably an Au film mainly composed of gold, a Ta film mainly composed of tantalum, an Ni film mainly composed of nickel, or a Ti film mainly composed of titanium, and it is more preferably an Au film or a Ta film. The metal film may be composed of an alloy of the foregoing metal elements. In the present embodiment, “mainly composed of” means 50 wt% or more in the metal film, and is preferably 90 wt% or more or 99 wt% or more.

The alignment marker AM needs only be positioned on the outermost surface of the optical waveguide layer 50. That is, it is only necessary that no other member is provided on the alignment marker AM in a lamination direction of the optical waveguide layer 50. For example, as shown in FIGS. 1 and 2, the alignment marker AM may be formed as a metal film directly on the flat optical waveguide layer 50. The alignment marker AM may be configured to be formed by removing a region of the optical waveguide layer 50 in which the alignment marker AM is to be provided such that the entire surface of the optical waveguide chip 45 in the z direction is flat. The alignment marker AM may be formed by removing a region of the optical waveguide layer 50 in which the alignment marker AM is to be provided such that only a region of the optical waveguide chip 45 in which the alignment marker AM is to be positioned has a recessed shape.

The optical waveguide layer 50 is formed on the optical waveguide substrate 40. In addition, as described above, the laser diodes 30 are mounted on the subcarriers (base mounts) 20. The optical waveguide substrate 40 and the subcarriers 20 are metal-bonded and integrated. This metal bonding enables precise optical axis arrangement and realizes miniaturization.

The optical waveguide layer 50 is produced on the upper surface 41 so as to be integrated with the optical waveguide substrate 40 by a semiconductor process including known photolithography and dry etching used when forming fine structures such as circuits. As shown in FIG. 2, the optical waveguide layer 50 is provided with the same number of cores 51-1, 51-2, and 51-3 as the laser diodes 30-1, 30-2, and 30-3, and a cladding 52 surrounding the cores 51-1, 51-2, and 51-3. The thickness of the cladding 52 and the dimensions of the cores 51-1, 51-2, and 51-3 in the width direction are not particularly limited. For example, the cores 51-1, 51-2, and 51-3 having the width-direction dimensions of several micrometers are arranged in the cladding 52 having a thickness of approximately 50μm.

For example, the cores 51-1, 51-2, and 51-3 and the cladding 52 are composed of quartz. Hereinafter, this may be referred to as a quartz-based PLC. The refractive indices of the cores 51-1, 51-2, and 51-3 are higher than the refractive index of the cladding 52 by a predetermined value. Accordingly, light input to each of the cores 51-1, 51-2, and 51-3 propagates through each core while being totally reflected at the interface between each core and the cladding 52. For example, the cores 51-1, 51-2, and 51-3 are doped with an impurity such as germanium (Ge) in an amount corresponding to the predetermined value described above.

As shown in FIGS. 1 to 3, the cores 51-1, 51-2, and 51-3 are gathered into one before reaching an output port 64 of the optical waveguide layer 50. That is, the cores 51-1, 51-2, and 51-3 sequentially merge as they extend forward in the y direction and merge into a single core 51-4. In order to prevent leakage light from the cores 51-1, 51-2, and 51-3, it is preferable that each of the cores 51-1, 51-2, and 51-3 be connected to the core 51-4 with a radius of curvature equal to or greater than a predetermined radius of curvature.

The cores 51-1 to 51-3 are constituted of members having a higher refractive index than the cladding constituting a region other than the cores 51-1 to 51-4 in the optical waveguide layer 50. For example, the cladding is made of SiInO, SiO₂, Al₂O₃, MgF₂, La₂O₃, ZnO, HfO₂, MgO, Y₂O₃, CaF₂, In₂O₃, a mixture thereof, or the like. For example, the core is composed of lithium niobate, SiO₂, SiN, or the like. The composition of lithium niobate is LiₓNbA_{y}O_{z}. In the formula, A is an element other than Li, Nb, and O. In the formula, x is 0.5 to 1.2 and is preferably 0.9 to 1.05. In the formula, y is 0 to 0.5. In the formula, z is 1.5 to 4.0 and is preferably 2.5 to 3.5. For example, the element A is K, Na, Rb, Cs, Be, Mg, Ca, Sr, Ba, Ti, Zr, Hf, V, Cr, Mo, W, Fe, Co, Ni, Zn, Sc, or Ce, and two or more kinds of these elements may be combined.

Through metal bonding between the optical waveguide substrate 40 and the subcarriers 20, each core and the corresponding laser diode are arranged so as to face each other in a state where accurate optical axis alignment has been performed such that the centers of the input ports of the respective cores 51-1, 51-2, and 51-3 of the optical waveguide layer 50 substantially coincide with the optical axes of light output from the corresponding laser diodes 30-1, 30-2, and 30-3.

As shown in FIG. 3, the input surface 50A of the optical waveguide layer 50 is arranged so as to face output surfaces 31 of the laser diodes 30. Specifically, an output surface 31-1 of the laser diode 30-1 faces the input port 51A-1 of the optical waveguide 51-1. In the x direction and the z direction, the optical axis of red light emitted from the laser diode 30-1 substantially overlaps the center of the input port 51A-1. Similarly, an output surface 31-2 of the laser diode 30-2 faces the input port 51A-2 of the optical waveguide 51-2. In the x direction and the z direction, the optical axis of green light emitted from the laser diode 30-2 substantially overlaps the center of the input port 51A-2. An output surface 31-3 of the laser diode 30-3 faces the input port 51A-3 of the optical waveguide 51-3. In the x direction and the z direction, the optical axis of blue light emitted from the laser diode 30-3 substantially overlaps the center of the input port 51A-3. With such a configuration and arrangement, at least a part of red light, green light, and blue light emitted from the laser diodes 30-1, 30-2, and 30-3 can be input to the optical waveguides 51-1, 51-2, and 51-3.

As shown in FIG. 2, red light, green light, and blue light emitted from the laser diodes 30-1, 30-2, and 30-3 are respectively input to the cores 51-1, 51-2, and 51-3 and then propagate through the respective cores. The red light and green light propagating through the cores 51-1 and 51-2 are coupled at the predetermined merging position 57-1 behind a merging position 57-2 in the y direction. The coupled red light and green light and the blue light propagating through the core 51-3 are combined at the merging position 57-2. The RGB light coupled at the merging position 57-2 propagates through the core 51-4, reaches the output port 64, and is output from the output port 64.

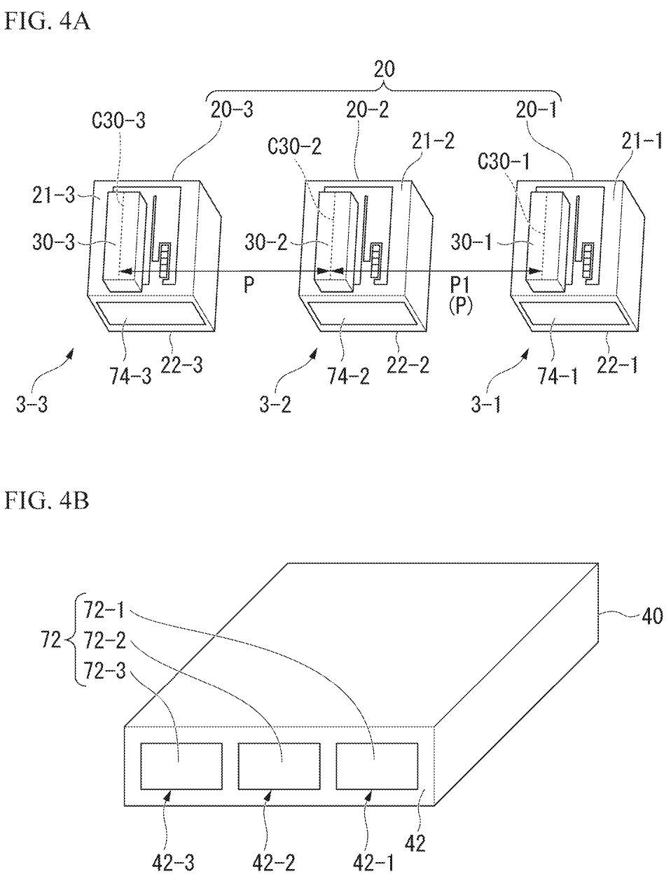

FIG. 4A shows an enlarged view of a configuration of the laser diodes 30 formed on the base mounts 20. The laser diode 30 is formed on the base mount 20 together with an active layer 35 corresponding to an output portion, electrode portions such as a cathode and an anode electrically connected to the active layer 35, and the like. In FIG. 4A, the width-direction centers of the output portions are indicated by the reference signs C30-1 to C30-3, respectively. As for positional alignment in the x direction, the width-direction centers C30-1 to C30-3 are positionally aligned with the input ports 51A-1 to 51A-3.

### Bonding Portion

The three individual base mounts 20-1, 20-2, and 20-3 and the optical waveguide substrate 40 are bonded with the metal films M therebetween. FIG. 4B shows a perspective view of the optical waveguide substrate 40. The metal films M are arranged between the respective base mount-side bonding surfaces 22-1, 22-2, and 22-3 of the three individual base mounts 20-1, 20-2, and 20-3 and the three substrate-side bonding portions 42-1, 42-2, and 42-3 corresponding to the respective base mount-side bonding surfaces 22-1, 22-2, and 22-3 and arranged apart from each other on the bonding surface 42 of the optical waveguide substrate 40. The metal films M are arranged only on the substrate-side bonding portions 42-1, 42-2, and 42-3 arranged apart from each other. Since the metal films M are separate films rather than continuously formed films, occurrence of capacitive coupling is curbed, and crosstalk is prevented.

The metal films M shown in FIGS. 2 and 3 are depicted as a three-layer structure for convenience, reflecting the producing process of the metal films M (which may also be referred to as a bonding process between the base mounts and the optical waveguide substrate). In addition, in description of the metal films M, each of the three layers may be described separately.

That is, the metal films M shown in the drawings are depicted, for convenience, as being constituted of three layers: first metal films 74 (74-1, 74-2, 74-3) arranged on the respective base mount-side bonding surfaces 22-1, 22-2, and 22-3 of the three individual base mounts 20-1, 20-2, and 20-3; second metal films 72 (72-1, 72-2, 72-3) arranged on the substrate-side bonding portions 42 corresponding to the respective base mount-side bonding surfaces 22-1, 22-2, and 22-3 and arranged apart from each other on the bonding surface 42 of the optical waveguide substrate 40; and eutectic layers 73 arranged between the first metal films 74 and the second metal films 72.

In actual bonding, when the first metal films and the second metal films are sufficiently thin, alloy layers (eutectic layers) are formed, and the first metal films and the second metal films do not remain. Meanwhile, when either one of the first metal films and the second metal films is thick, only the surface sides of the thick metal films may become eutectic, leaving parts on the base mount side or the optical waveguide substrate side, while other parts of the metal films may entirely become eutectic. However, it becomes difficult to clearly distinguish them as layers (distinguishing the interface).

In this manner, in actual bonding, the film structures of the metal films M vary depending on the conditions of the producing process of the metal films M, and the drawings conceptually depict characteristic aspects of the film structures.

For example, a structure may be adopted in which one or both of the first metal films 74 and the second metal films 72 remain relatively, or a structure may be adopted in which the first metal films 74 and the second metal films 72 are alloyed in their entirety to form eutectic layers.

For example, the first metal films 74 are formed on the entire bonding surfaces 22 of the base mounts 20, or in their entirety excluding edges. The first metal films 74 and the second metal films 72 are positionally aligned so as to overlap each other. When the subcarriers 20 are irradiated with laser light, or when the films are directly irradiated through the subcarriers 20, the first metal films 74 and the second metal films 72 are heated and melt. When the first metal films 74 and the second metal films 72 are heated by laser light in a contact state, components of the second metal films 72 become eutectic and diffuse into the first metal films 74.

The second metal films 72 arranged on the substrate-side bonding portions 42-1, 42-2, and 42-3 are preferably composed of Sn or an Sn-containing alloy such as Sn-Ag-Cu. In addition, the first metal films 74 arranged on the base mount-side bonding surfaces 22-1, 22-2, and 22-3 are preferably composed of metals which can become eutectic with Sn, and can include, for example, one selected from the group consisting of Au, Si, Al, Ni, Pb, Zn, and Pt, or an alloy thereof. The three-layer structures of the metal films M shown in FIGS. 2 and 3 may be in the reverse order. That is, a structure may be adopted in which the second metal films 72 are arranged on the base mount 20 side and the first metal films 74 are provided on the optical waveguide substrate 40 side. These metal films are formed by sputtering, vapor deposition, or the like.

In the optical element assembly 100 according to the present embodiment, since the alignment marker AM is provided on the outermost surface of the optical waveguide layer 50 and on the inner side of the outer peripheral edge, miniaturization of the elements can be achieved without concern for the influence on the size of the alignment marker on the output surface. In addition, even when the elements are miniaturized, the alignment marker AM can be easily detected by observing the optical waveguide layer 50 in a plan view, and the laser diode assembly 3 can be positionally aligned with high accuracy based on the coordinate component (positional information) of the alignment marker AM.

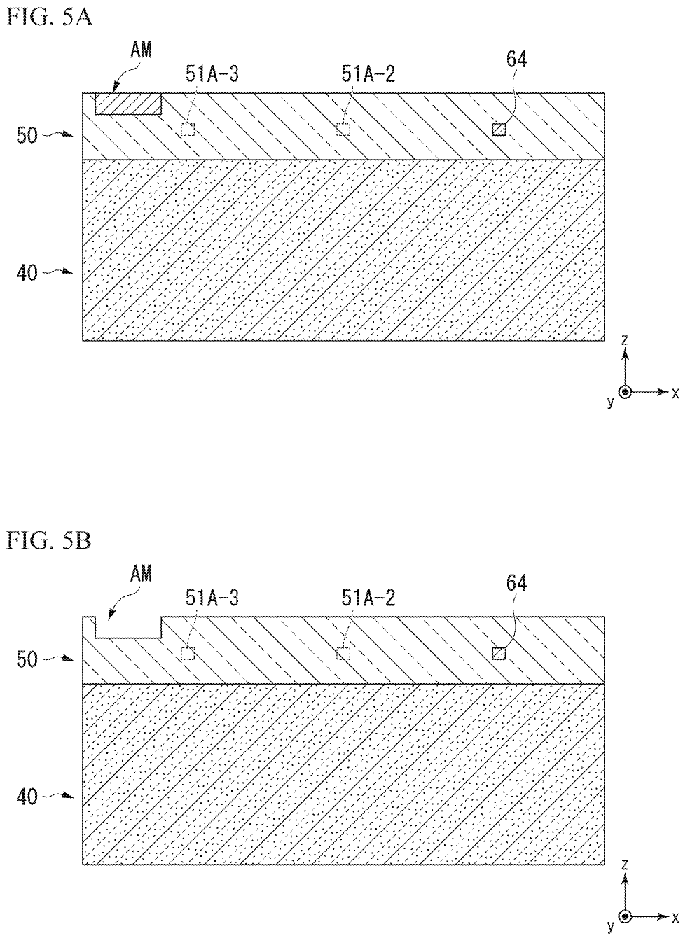

In the foregoing embodiment, a configuration has been exemplified in which the alignment marker AM is formed by providing metal films on the optical waveguide layer 50, but the present disclosure is not limited to the foregoing example. As shown in FIG. 5A, the alignment marker AM may be a metal film provided in a region where a part of the optical waveguide layer 50 has been removed. In such a configuration, the optical waveguide layer 50 is formed, and then a region for forming the alignment marker AM is removed by etching. Subsequently, the alignment marker AM can be formed by vapor deposition, sputtering, CVD, or the like. In addition, as shown in FIG. 5B, the alignment marker AM may be a recessed portion. Although a configuration in which the alignment marker AM is a recessed portion is more difficult to be detected than a configuration in which the alignment marker AM is a metal film, the contour can be detected as a dark line by observation from above, and thus the present embodiment can also be carried out with such a configuration.

### Method for Manufacturing Optical Element Assembly

Hereinafter, a method for manufacturing an optical element assembly according to one embodiment of the present disclosure will be described by way of an example of a method for manufacturing the optical element assembly 100 according to the foregoing embodiment. The method for manufacturing an optical element assembly according to one embodiment of the present disclosure includes a bonding step of bonding a laser diode assembly to the optical waveguide chip 45 in which the optical waveguide layer 50 having the alignment marker AM is formed. The optical waveguide chip 45 is a member obtained by laminating the optical waveguide layer 50 on the optical waveguide substrate 40 and forming the laminate into a chip. The alignment marker AM is provided at a position inward from the outer peripheral edge on the outermost surface of the optical waveguide layer 50. In the bonding step, positionally alignment is performed while the optical waveguide layer 50 is observed in a plan view, and the laser diode assembly is bonded to the optical waveguide chip 45 in a state where the optical waveguide layer 50 is positionally aligned.

The method for manufacturing an optical element assembly according to the present embodiment includes an alignment marker forming step and a bonding step, for example.

### Alignment Marker Forming Step

In the alignment marker forming step, the alignment marker AM is formed at a position inward from the outer peripheral edge on the outermost surface of the optical waveguide layer 50. The alignment marker forming step may be performed on an optical waveguide substrate in a wafer state, may be performed on an optical waveguide substrate processed into a bar shape, or may be performed on a chip-formed member which is obtained by forming a bar-shaped member into a chip. In the present embodiment, a case will be described as an example in which the alignment marker AM is formed on the optical waveguide chip 45 that is a chip-formed member.

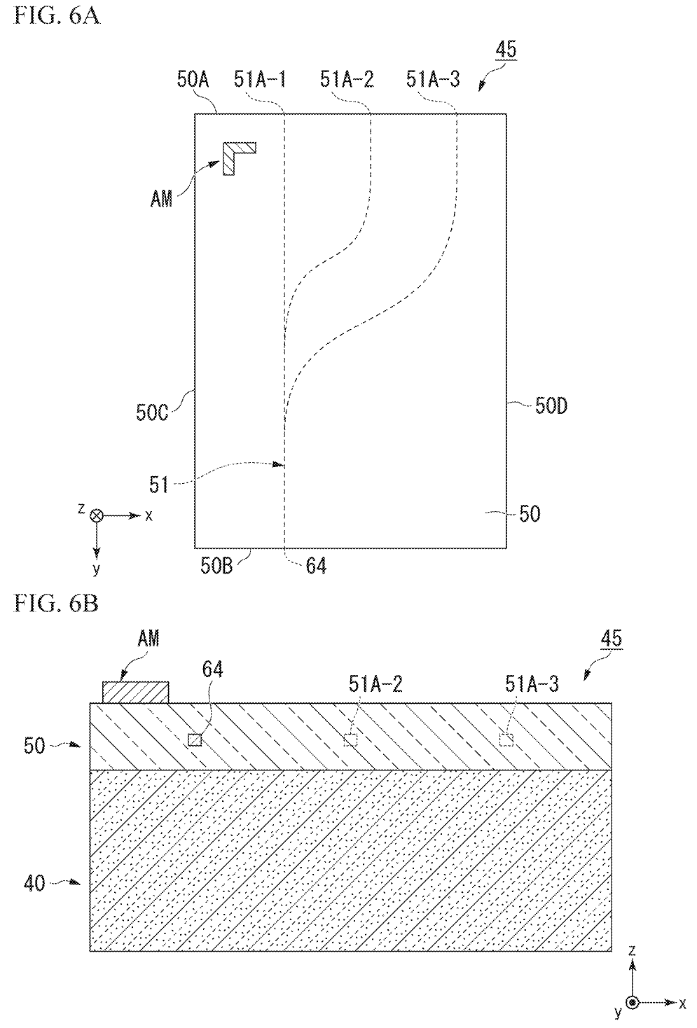

FIG. 6A is a plan view showing an example of a configuration of an optical waveguide chip that can be used in the method for manufacturing an optical element assembly according to one embodiment of the present disclosure, and FIG. 6B is a view of the optical waveguide chip as observed from a lateral side. As shown in FIGS. 6A and 6B, the optical waveguide chip 45 includes the optical waveguide substrate 40 and the optical waveguide layer 50 formed on the optical waveguide substrate 40.

The optical waveguides 51 are formed inside the optical waveguide layer 50. In the example shown in FIGS. 6A and 6B, a configuration is exemplified in which the alignment marker AM is provided on the outer side of the optical waveguide chip 45 in the width direction with respect to the optical waveguides 51. However, the alignment marker AM may be configured to be provided at a position overlapping the optical waveguides 51, may be provided between the input ports 51A-1 and 51A-2 in the width direction, or may be provided between the input ports 51A-2 and 51A-3.

The alignment marker AM forming step can be performed by sputtering, chemical vapor deposition (CVD), vapor deposition, or the like. Techniques such as photomasks, vapor deposition, sputtering, lift-off, and etching can be utilized such that the alignment marker AM can be formed into a predetermined shape.

### Bonding Step

Next, positional alignment is performed while the optical waveguide layer 50 is observed in a plan view, and the laser diode assembly 3 is bonded to the optical waveguide chip 45. In the method for manufacturing an optical element assembly according to the present embodiment, positional alignment is performed using two optical systems, such as an optical system for detecting laser output and an optical system for reading markers. This is because, within such a range, the coordinates of the alignment marker AM can be identified with sufficient accuracy.

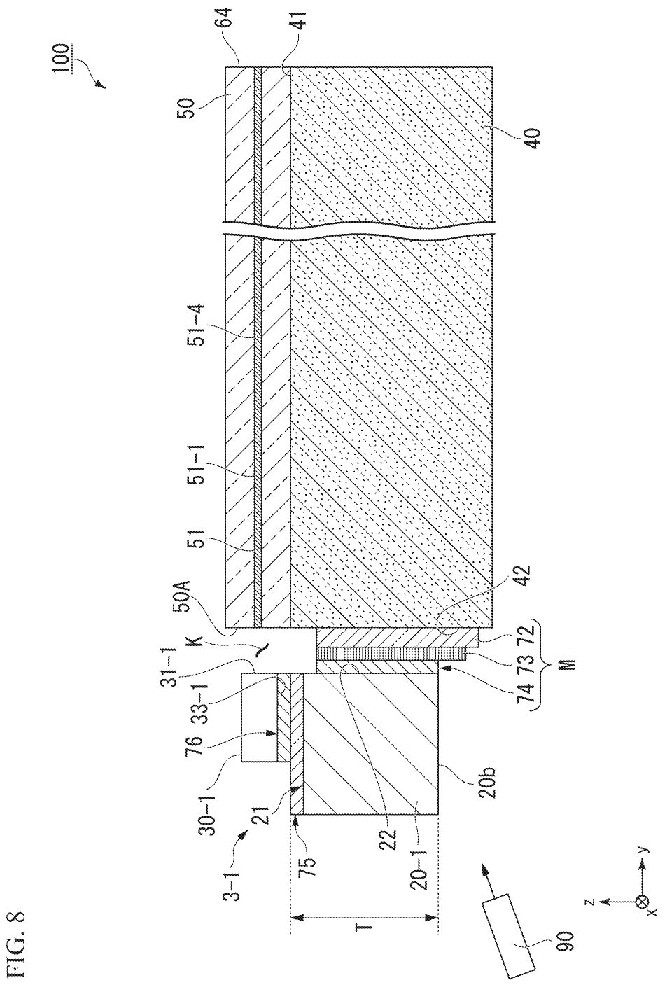

FIGS. 7 and 8 are explanatory schematic views of a configuration of the method for manufacturing an optical element assembly according to one embodiment of the present disclosure, showing a state of the bonding step. Positional alignment is performed on the basis of the coordinates (positional information) of the alignment marker AM identified by observing the optical waveguide layer 50 in a plan view, and relative coordinates representing a relative positional relationship between the alignment marker AM and the input ports 51A-1 to 51A-3 ascertained in advance. Therefore, first, the coordinates of the alignment marker AM are read by the optical system for reading markers. Next, the coordinates of the input ports 51A-1 to 51A-3 are identified on the basis of the coordinates of the alignment marker AM.

Next, positional alignment is performed on the basis of the coordinates such that the input ports 51A face the active layer 35 of the laser diode assembly 3. More specifically, positional alignment is performed such that the width-direction centers C30-1 to C30-3 face the input ports 51A-1 to 51A-3. In addition, in the positionally aligned state, the substrate-side bonding portions 42-1 to 42-3 of the optical waveguide substrate 40 and the base mount-side bonding surfaces 22-1 to 22-3 of the laser diode assembly 3 are brought into contact with each other.

In a state where the laser diode assembly 3 is positionally aligned, the subcarrier 20 is irradiated with laser light from a laser 90, and the first metal film 74, the second metal film 72, and the third metal film (eutectic film) 73 are softened or melted by heat transfer from the subcarrier 20. As described above, laser light irradiation may be performed after positional alignment is performed by fixing the laser diode assembly 3 and the optical waveguide substrate 40 so as not to move, and laser light irradiation is performed to bond them. In addition, while laser light irradiation is performed, accurate positional alignment may be performed by finely adjusting the laser diode assembly 3 and the optical waveguide substrate 40. In order to achieve accurate positional alignment, before laser light irradiation is performed from the laser 90 or during fine adjustment while irradiation is performed, a preliminary adjustment step may be performed in which fine adjustment is performed while checking the intensity of each color component by causing each of the laser diodes 30-1 to 30-3 to emit light, causing the emitted light to pass through the cores 51-1 to 51-3, and identifying the laser light output from the output port 64 using the optical system for detecting laser output. For example, the optical system for detecting laser output is arranged in a direction normal to the output surface 50B so as to face the output port 64.

As for the laser 90, a known laser capable of heating the first metal film 74 and the second metal film 72 to a temperature at which they become eutectic be used. However, it is preferable to use a laser capable of irradiating laser light having a wavelength of 1064nm, such as a YAG laser, or a longer wavelength. In the bonding step, when irradiation of laser light having a short wavelength is performed, the metal films M are indirectly heated via the base mounts 20.

In the method for manufacturing an optical element assembly according to the present embodiment, by providing the alignment marker AM on the outermost surface of the optical waveguide layer 50, it is possible to cope with miniaturization of the optical element assembly and achieve highly accurate positional alignment.

In some optical devices, the optical waveguide layer is extremely thin, measuring only a few micrometers. Therefore, as described below, it is difficult to cope with miniaturization when an alignment marker is formed on the input surface or the output surface of the optical waveguide layer, and positional alignment is performed by observing the optical system from a lateral side. For example, due to the thickness of the optical waveguide layer, it may be difficult to remove a part of the optical waveguide layer so as to make a blank region and to embed a metal thin film. In addition, even if the thickness is sufficient, since the thickness of a metal film which can be detected by observation with the optical system from a lateral side is 10μm or more, for example, it may be difficult to form a metal film having such a thickness. Particularly, when a metal film should be formed by a dry process, it is not realistic to make a metal film having a detectable thickness. In addition, a plating process may be required to facilitate optical detection, or damage may occur after film formation, making it difficult to maintain the originally required shape. Insufficient maintenance of the shape affects the positional alignment accuracy.

In contrast, according to the present embodiment, even when it is difficult to form an identifiable alignment marker on the input surface or the output surface due to the thickness of the optical waveguide layer or the like, the alignment marker AM having a sufficient size can be easily formed without hindering miniaturization of the element by forming it on the outermost surface of the optical waveguide layer and observing it in a direction normal to the optical waveguide layer 50 (upward in the z direction, a plan-view direction).

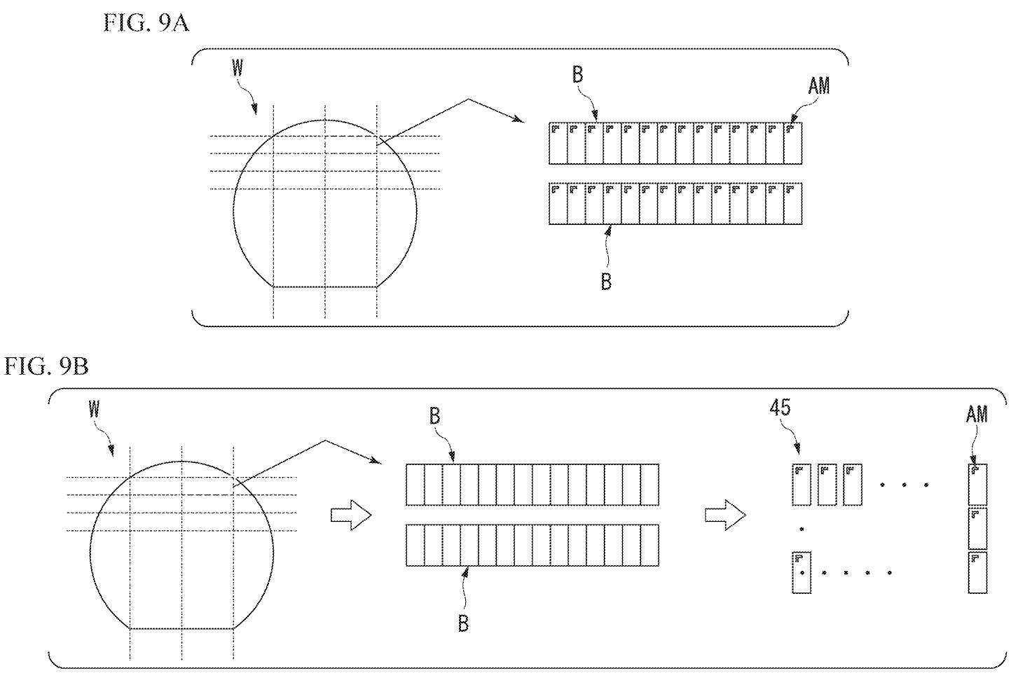

FIGS. 9A and 9B are views showing a modification example of the method for manufacturing an optical element assembly according to one embodiment of the present disclosure. The timing of forming the alignment marker AM is not limited to after the optical waveguide substrate is formed into chips as in the foregoing configuration, and it may be formed before chip formation. Here, the foregoing optical waveguide chip 45 can be obtained through a step of forming an optical waveguide layer including a plurality of optical waveguides on a wafer (substrate) (optical waveguide layer forming step), a step of cutting out a plurality of optical waveguide bar members B including the optical waveguide layer from the wafer (bar member cutting-out step), a step of forming a plurality of second metal films 72 (second metal film formation step), and dicing (dicing step). As shown in FIG. 9A, the alignment marker AM may be formed by performing the alignment marker forming step after the bar member cutting-out step and before the dicing step. In addition, as shown in FIG. 9B, the alignment marker forming step may be performed after the optical waveguide chip 45 is formed in the dicing step.

In this manner, the alignment marker forming step can be performed at any stage as long as it is before the bonding step. When the alignment marker forming step is performed before the dicing step, the bonding step may be performed before the dicing step. That is, a plurality of diode assemblies may be bonded to a bar member in which a plurality of optical waveguides that will later become parts of the individually independent optical waveguide chip 45 are connected, and then dicing may be performed. Specifically, any one input port of the optical waveguide layers is identified using the coordinates of the alignment marker AM, the laser diode assembly is positionally aligned, and the laser diode assembly is bonded to the optical waveguide bar member in a state where the laser diode assembly is positionally aligned. This operation is performed for all of the plurality of optical waveguide layers. In such a manufacturing method, the number of steps required to produce elements which will become a plurality of optical element assemblies can be reduced. In addition, in this case, if at least one alignment marker AM is provided on one bar member B, it is possible to ascertain the relative coordinates of all the input ports on the bar member B with respect to the alignment marker AM, and therefore it is not necessary to form alignment markers in all regions that will become individual chips. In addition, the alignment marker AM may be formed in regions that will become individual chips at the wafer (substrate) stage before the bar member cutting-out step and after the optical waveguide layer forming step.

### Optical Module

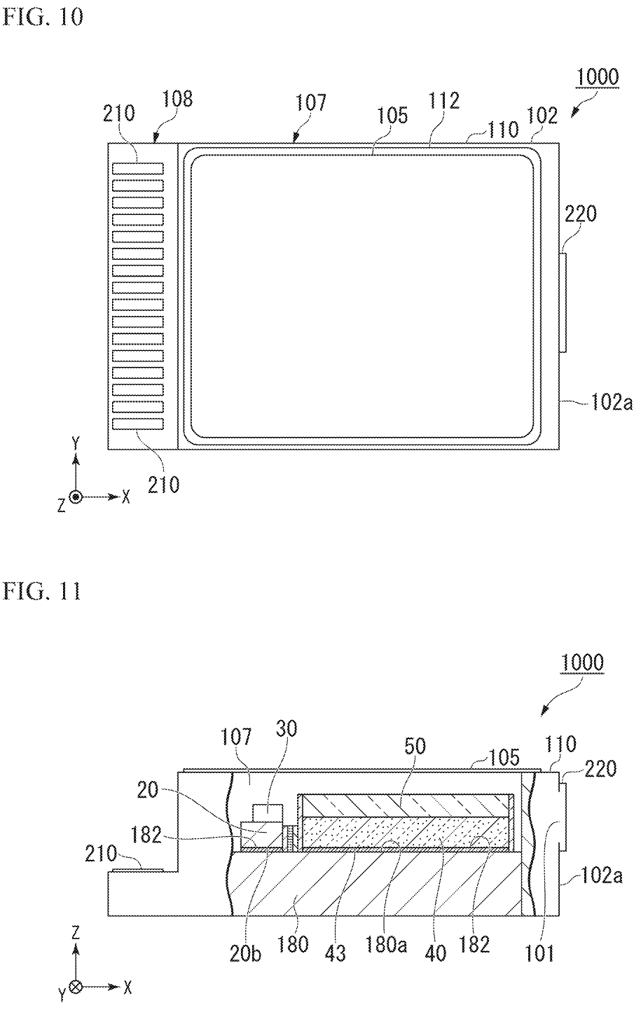

FIG. 10 is a schematic plan view of an optical module according to the present embodiment. FIG. 11 is a schematic cross-sectional view of the optical module shown in FIG. 10 taken along an X-Z plane.

In an optical module 1000 shown in FIG. 10, the optical element assembly according to the foregoing embodiment is accommodated in a package 110. The optical element assembly shown in FIG. 10 may also be referred to as a laser assembly.

Inside the package 110, known constituent elements other than the optical element assembly according to the foregoing embodiment may be provided. For example, a light receiver (photodetector: PD) can be accommodated.

When a PD is provided, variations in optical output of the laser diode can be checked by observing the current flowing through the PD. In addition, a drive current of the laser diode can be controlled such that the output becomes constant by monitoring the current flowing through the PD.

The package 110 includes a main body 102 having a cavity structure, and a cover 105 covering the main body 102.

The main body 102 includes a bottom portion on which members accommodated therein are mounted, and wall portions (side wall portions) 102a arranged so as to surround the members from lateral sides.

A light-transmitting window 101 allowing laser light L output from the laser diodes 30 to be optically transmitted therethrough is formed in the wall portion (side wall portion) 102a arranged in a direction in which laser light is output.

Among the side wall portions of an accommodation portion 107, the light-transmitting window (opening) 101 is formed in the side wall portion 102a in the vicinity of the output portion of the laser light L output from the optical module 1000. The opening 101 is formed substantially centered at a position intersecting the optical axis of laser light output at the side wall portion 102a. The opening 101 is covered by a glass plate 220 from outside the side wall portions 102a with no gap therebetween. That is, the accommodation portion 107 is hermetically sealed by the glass plate 220 in addition to the cover 105. Although the glass plate 220 is used for hermetic sealing, the material is not limited to a glass plate as long as laser light can be transmitted through. Anti-reflection films (not shown) may be provided on both plate surfaces of the glass plate 220.

An electrode portion 108 is arranged on the front side of the accommodation portion 107 in the x direction, that is, on a rearward side in the x direction. The upper surface of the electrode portion 108 is positioned below the upper surface of the accommodation portion 107. The bottom surface of the electrode portion 108 is positioned at substantially the same height as the bottom surface of the accommodation portion 107. A plurality of external electrode pads 210 are provided on the upper surface of the electrode portion 108 with an interval therebetween in the y direction.

As shown in FIG. 10, a base 180 for installing an optical module including the laser diodes 30, the subcarriers 20 including the laser diodes 30 mounted thereon, the PLC 50, and the optical waveguide substrate 40 including the PLC 50 formed thereon is provided at a predetermined position in the bottom portion of the accommodation portion 107. This optical module is provided on the base 180. That is, this optical module is arranged in the internal space of the accommodation portion 107. Since this optical module is formed such that bottom surfaces (base mount bottom surfaces) 20b of the subcarriers (base mounts) 20 and the bottom surface (substrate bottom surface) 43 of the optical waveguide substrate 40 are positioned on substantially the same plane S, both the subcarriers 20 and the optical waveguide substrate 40 of this optical module are bonded to an upper surface 180a (one inner surface) of the base 180.

The bottom surfaces (base mount bottom surfaces) 20b of the subcarriers 20 and the bottom surface (substrate bottom surface) 43 of the optical waveguide substrate 40 need only be bonded to the upper surface 180a (one inner surface) of the base 180 with an adhesion layer 182 therebetween. In order to enhance thermal conductivity properties, a material obtained by mixing a filler into a resin is used for this adhesion layer 182. Examples of resins constituting the adhesion layer 182 include epoxy resin. In addition, copper powder, aluminum powder, alumina powder, or the like can be used as the filler for improving the thermal conductivity properties of the resin.

In order to maintain a certain level of thermal conductivity properties, the thermal conductivity of the adhesion layer 182 is preferably 0.5 W/m·K or higher, the thermal conductivity is more preferably 1 W/m·K or higher, and the thermal conductivity is still more preferably 4 W/m·K or higher.

In this manner, by bonding both the subcarriers 20 and the optical waveguide substrate 40 of the optical module to the upper surface 180a of the base 180 of the package 110, heat generated by operation of the laser diodes 30 can be efficiently dissipated toward the base 180 from both the bottom surfaces (base mount bottom surfaces) 20b of the subcarriers 20 and the bottom surface (substrate bottom surface) 43 of the optical waveguide substrate 40. Furthermore, by bonding both the bottom surfaces 20b of the subcarriers 20 and the bottom surface 43 of the optical waveguide substrate 40 using an adhesion layer made of a resin mixed with a filler, heat can be efficiently propagated toward the base 180 from both the bottom surfaces 20b of the subcarriers 20 and the bottom surface 43 of the optical waveguide substrate 40.

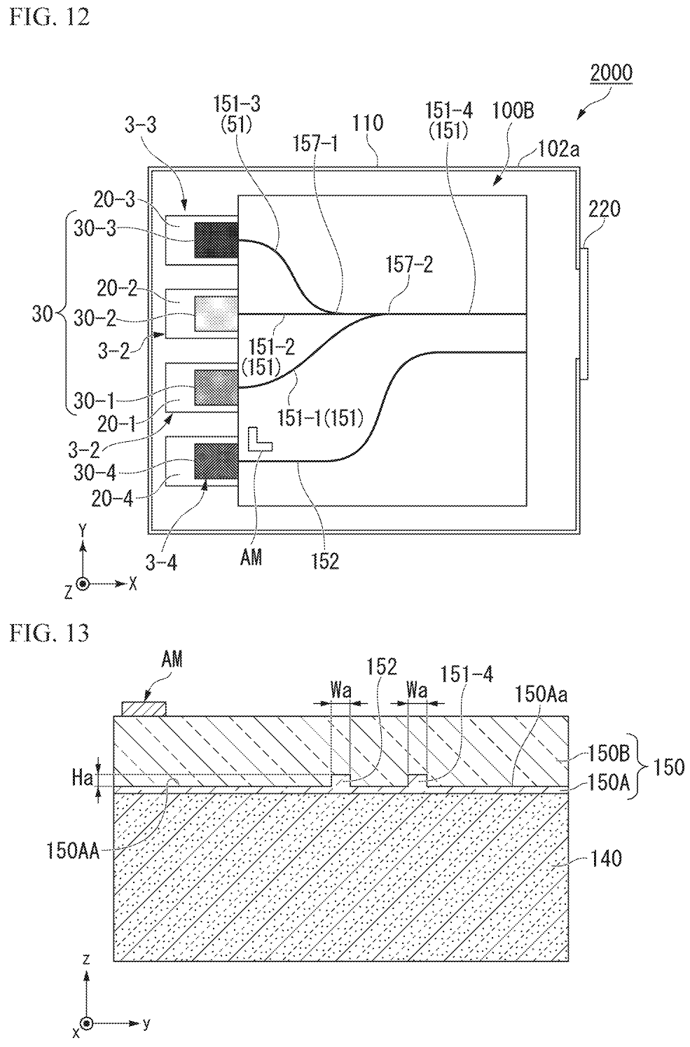

FIG. 12 is a conceptual view of an optical module including an optical waveguide layer including optical waveguides, and is an explanatory plan view of a configuration inside a package of the optical module in FIG. 10. FIG. 13 is a schematic plan view of the optical module shown in FIG. 12 as viewed from the output surface.

The same reference signs may be applied to members common to those of the optical element assembly described above, and description thereof may be omitted. FIG. 12 shows an example in which the optical element assembly includes a near-infrared laser diode in addition to the RGB laser diodes, serving as the laser diodes. Since near-infrared lasers are invisible, they can be used for eye tracking.

In an optical module 2000 shown in FIG. 12, an optical element assembly 100B is accommodated in the package 110. The optical element assembly 100B includes the RGB laser diodes 30, the base mounts 20 including the RGB laser diodes 30 mounted thereon, a near-infrared laser diode 30-4, a base mount 20-4 including the near-infrared laser diode 30-4 mounted thereon, an optical waveguide substrate 140 including a PLC 150 formed on a main surface, and the metal films 72, 73, and 74 for bonding the base mounts 20 and the base mount 20-4 to the optical waveguide substrate 140.

Similar to the laser diodes 30, the near-infrared laser diode 30-4 is mounted on the subcarrier 20-4, and the PLC 150 is formed on the optical waveguide substrate 140.

Inside the package 110, the optical module 2000 includes the PLC 150 including optical waveguides 151 (151-1, 151-2, 151-3) guiding laser light output from the laser diodes 30, and an optical waveguide 152 guiding near-infrared laser light output from the near-infrared laser diode 30-4.

In the optical module 2000 as well, the optical waveguide substrate 140 including the PLC 150 formed thereon is metal-bonded and integrated with the subcarriers 20 including the laser diodes 30 mounted thereon and the subcarrier 20-4 including the near-infrared laser diode 30-4 mounted thereon.

This metal bonding enables precise optical axis arrangement and realizes miniaturization.

Examples of the optical waveguide substrate 140 include a sapphire substrate, an Si substrate, and a thermally oxidized silicon substrate.

In the optical module 2000, the PLC 150 includes an optical waveguide film 150A including the optical waveguides 151 and the optical waveguide 152, and a waveguide cladding layer 150B formed on the optical waveguide film 150A so as to cover the optical waveguides 151 and the optical waveguide 152. The waveguide cladding layer 150B has a lower refractive index than the optical waveguide film 150A. The optical waveguide film 150A corresponds to the foregoing core, and the waveguide cladding layer 150B corresponds to the foregoing cladding.

When the optical waveguide film 150A is constituted by the lithium niobate film, for example, a c-axis-oriented lithium niobate film can be used. The lithium niobate film is an epitaxial film epitaxially grown on the optical waveguide substrate 140, for example. An epitaxial film is a single-crystal film whose crystal orientation is aligned by a base substrate. The epitaxial film is a film having a single crystal orientation in the z direction and an in-plane xy direction, and the crystal is oriented with alignment in all of x-axis, y-axis, and z-axis directions. Whether the film formed on the optical waveguide substrate 140 is an epitaxial film can be proven by, for example, checking the peak intensity and the pole at the orientation position in 2θ-θ X-ray diffraction.

The thickness of the optical waveguide film 150A is 2μm or smaller, for example. The thickness of the lithium niobate film refers to the thickness of a part other than a ridge portion. If the thickness of the lithium niobate film is large, crystallinity may deteriorate.

In addition, the thickness of the optical waveguide film 150A is equal to or greater than approximately one-tenth of the wavelength of light to be used, for example. If the thickness of the optical waveguide film 150A is small, confinement of light becomes weak so that light may leak into the optical waveguide substrate 140 or the waveguide cladding layer 150B.

The optical waveguides 151 and the optical waveguide 152 are optical paths in which light is propagated. The optical waveguides 151 and the optical waveguide 152 are ridges protruding from a first surface 150AA of a slab layer 150Aa of the optical waveguide film 150A. Hereinafter, the optical waveguide 151-1, the optical waveguide 151-2, the optical waveguide 151-3, and the optical waveguide 152 may be referred to as a ridge 151-1, a ridge 151-2, a ridge 151-3, and a ridge 152, respectively. The first surface 150AA is an upper surface of a part other than the ridge portion (slab layer 150Aa) of the optical waveguide film 150A. The optical waveguide film 150A is constituted of the ridges 151-1, 151-2, 151-3, and 152 and the slab layer 150Aa.

A ridge 151-4 and the ridge 152 shown in FIG. 13 have a rectangular cross-sectional shape, but any shape capable of guiding light may be adopted. For example, a trapezoidal shape, a triangular shape, or a semicircular shape may be adopted. A width Wa in the y direction is preferably 0.3μm to 5.0μm, and the height of the ridge (protrusion height Ha from the first surface 150AA) is preferably 0.1μm to 1.0μm, for example.

As shown in FIG. 12, the optical waveguide 151-1, the optical waveguide 151-2, and the optical waveguide 151-3 are gathered into one before reaching the output surface of the PLC 150. That is, the optical waveguide 151-1, the optical waveguide 151-2, and the optical waveguide 151-3 sequentially merge as they extend forward in the x direction and merge into the single optical waveguide 151-4. In order to prevent leakage light from the optical waveguide 151-1, the optical waveguide 151-2, and the optical waveguide 151-3, it is preferable that each of the optical waveguide 151-1, the optical waveguide 151-2, and the optical waveguide 151-3 be connected to the optical waveguide 151-4 with a radius of curvature equal to or greater than a predetermined radius of curvature.

Through metal bonding between the optical waveguide substrate 140 and the subcarriers 20, each ridge and the corresponding laser diode are arranged so as to face each other in a state where accurate optical axis alignment has been performed such that the centers of the input ports of the respective ridges 151-1, 151-2, 151-3, and 152 of the PLC 150 substantially coincide with the optical axes of light output from the corresponding laser diodes 30-1, 30-2, 30-3, and 30-4 so as to be optically connected thereto.

The input ports of the optical waveguides 151-1, 151-2, 151-3, and 152 face the output ports of the respective laser diodes 30-1, 30-2, 30-3, and 30-4, positioning is performed such that light output from the output ports of the laser diodes 30-1, 30-2, 30-3, and 30-4 can be input to the respective input ports, and the laser diodes 30-1, 30-2, 30-3, and 30-4 are optically connected to the optical waveguides 151-1, 151-2, 151-3, and 152.

As shown in FIG. 12, red light, green light, and blue light emitted from the laser diodes 30-1, 30-2, and 30-3 are respectively input to the input ports of the respective optical waveguides (ridges) 151-1, 151-2, and 151-3, and are then propagated through the respective ridges. The blue light and the green light propagated through the ridges 151-3 and 151-2 are coupled at a predetermined merging position 157-1 behind a merging position 157-2 in the x direction. The coupled blue and green light and the red light propagated through the ridge 151-1 are coupled at the merging position 157-2. The RGB light coupled at the merging position 157-2 is propagated through the ridge 151-4, reaches the output surface, and is output from the output surface.

In addition, near-infrared light emitted from the near-infrared laser diode 30-4 is propagated through the ridge 152, reaches the output surface, and is output from the output surface.

Each of the optical waveguides 151-1, 151-2, 151-3, and 152 provided in the PLC 150 may be a Mach-Zehnder-type optical waveguide.

### XR Glasses

XR glasses according to the present embodiment include the optical module according to the foregoing embodiment mounted on glasses.

The XR glasses (eyeglasses) are eyeglass-type terminals, and “XR” is a collective term for virtual reality (VR), augmented reality (AR), and mixed reality (MR).

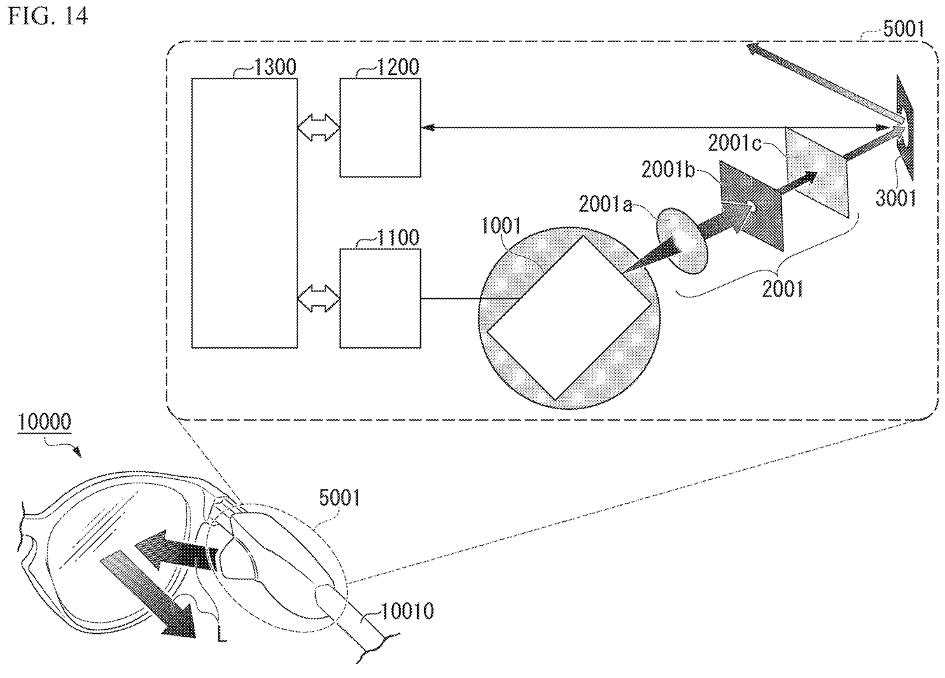

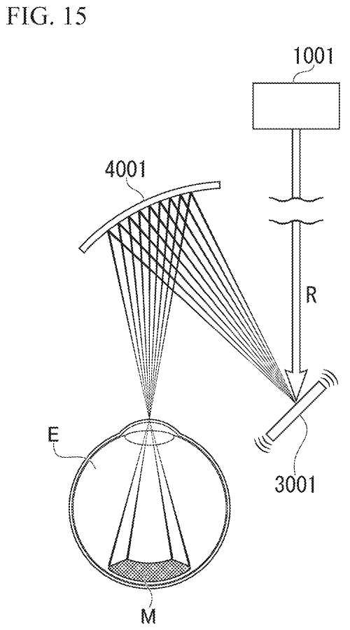

FIG. 14 shows an explanatory conceptual view of the XR glasses according to the present embodiment.

XR glasses 10000 shown in FIG. 14 include an optical module 1001 mounted on a frame 10010. The reference sign L indicates image display light.

In FIG. 14, the optical module 1001, an optical scanning mirror 3001, and an optical system 2001 connecting the optical module 1001 and the optical scanning mirror 3001 are collectively referred to as an optical engine 5001, in this specification. As for the optical module 1001, any of the optical modules according to the foregoing embodiment is used. The optical engine may also be referred to as an optical engine module.

For example, a light source having the RGB laser diodes constituted of the red laser diode 30-1, the green laser diode 30-2, and the blue laser diode 30-3, and the near-infrared laser diode 30-4 can be used for the optical module 1001.

FIG. 15 is a conceptual view showing a state where an image is directly projected onto a retina by laser light output from an optical module such as the XR glasses shown in FIG. 14. As shown in FIG. 15, laser light irradiated from the optical module 1001 attached to an eyeglass frame is reflected by the optical scanning mirror 3001, and the reflected light is reflected by a mirror 4001 reflecting the light in a direction toward a human eyeball E. The light enters the human eyeball E and can directly project an image (video) onto a retina M.

By providing an eye-tracking mechanism, an image is directly projected onto the retina while performing eye tracking. A known eye-tracking mechanism can be used.

For example, the optical scanning mirror 3001 is a MEMS mirror. In order to project a two-dimensional image, it is preferable that the optical scanning mirror 3001 be a two-axis MEMS mirror which vibrates so as to reflect laser light while changing angles in a horizontal direction (X direction) and a vertical direction (Y direction).

The optical system 2001 optically processing laser light output from the optical module 1001 includes a collimator lens 2001a, a slit 2001b, and an ND filter 2001c. This optical system is merely an example, and other configurations may be adopted.

The optical engine 5001 includes a laser driver 1100, an optical scanning mirror driver 1200, and a video controller 1300 controlling these drivers.

Hereinabove, an embodiment of the present disclosure has been described in detail. However, the present disclosure is not limited to the foregoing embodiment, and various omissions, replacements, modifications, and changes can be made within a range of the technical features of the present disclosure described in the claims. The embodiment and modifications thereof are included in the scope and the features of the invention, as well as in the scope of the invention described in the claims and their equivalents.

### INDUSTRIAL APPLICABILITY

The optical element assembly of the present disclosure is suitably applicable to optical engines and XR glasses.

### EXPLANATION OF REFERENCES

3, 3-1, 3-2, 3-3 Laser diode assembly
10 Optical element assembly
20, 20-1, 20-2, 20-3, 20-4 Base mount (subcarrier)
20b Bottom surface (base mount bottom surface)
21-1, 21-2, 21-3 Main surface
22, 22-1, 22-2, 22-3 Base mount-side bonding surface (bonding surface)
30, 30-1, 30-2, 30-3 Laser diode
30 Laser diode
30 RGB laser diode
30-1 Red laser diode
30-2 Green laser diode
30-3 Blue laser diode
31, 31-1, 31-2, 31-3 Output surface
35 Active layer 30-4 Near-infrared laser diode
40 Optical waveguide substrate
41 Upper surface
42 Bonding surface
42, 42-1, 42-2, 42-3 Substrate-side bonding portion
43 Bottom surface (substrate bottom surface)
45 Optical waveguide chip 50 Optical waveguide layer
50A Input surface
50B Output surface
50c, 50D Side surface
51 Optical waveguide
51-1, 51-2, 51-3 Optical waveguide (core)
51A-1, 51A-2, 51A-3 Input port
52 Cladding
57-1, 57-2 Merging position
64 Output port
72, 72-1, 72-2, 72-3 Second metal film
72, 73, 74 Metal film
73 Third metal film (eutectic film)
74, 74-1, 74-2, 74-3 First metal film
75 First metal layer
76 Second metal layer
90 Laser
100, 100B Optical element assembly
101 Light-transmitting window (opening)
101 Opening
102 Main body
102a Wall portion (side wall portion)
105 Cover
107 Accommodation portion
108 Electrode portion
110 Package
140 Optical waveguide substrate
151, 151-1, 151-2, 151-3 Optical waveguide
151-1, 151-2, 151-3 Optical waveguide (ridge)
152 Optical waveguide (ridge)
157-1, 157-2 Merging position
180 Base 180a Upper surface
182 Adhesion layer
210 External electrode pad
220 Glass plate
1000, 1001 Optical module
1100 Laser driver
1200 Optical scanning mirror driver
1300 Video controller
2000 Optical module
2001 Optical system
2001a Collimator lens
2001b Slit
2001c ND filter
3001 Optical scanning mirror
4001 Mirror
5001 Optical engine
10000 XR glasses
10010 Frame B Optical waveguide bar member (bar member)
C30-1, C30-2, C30-3 Width-direction center
L Laser light

What is claimed is:

1. An optical element assembly comprising:
a laser diode; and
an optical waveguide layer including an optical waveguide guiding laser light output from the laser diode,
wherein the optical waveguide layer has an alignment marker, and
the alignment marker is provided on an outermost surface of the optical waveguide layer and is positioned on an inner side of an outer peripheral edge of the optical waveguide layer.

2. The optical element assembly according to claim 1,
wherein the alignment marker is a metal film.

3. The optical element assembly according to claim 2,
wherein the metal film is an Au film or a Ta film.

4. The optical element assembly according to claim 1,
wherein the alignment marker is a recessed portion.

5. The optical element assembly according to claim 1,
wherein a line width of the alignment marker is 20μm or more.

6. The optical element assembly according to claim 1,
wherein in a plan view, the alignment marker has an L-shape, and
each side constituting the L-shape is parallel to any one of an input surfaces, an output surface, and a side surface of the optical waveguide layer.

7. The optical element assembly according to claim 1, further comprising:
a base mount including the laser diode mounted on a main surface thereof;
an optical waveguide substrate including the optical waveguide layer provided on a main surface thereof; and
a plurality of metal films bonding the base mount and the optical waveguide substrate.

8. The optical element assembly according to claim 7, further comprising:
a plurality of the laser diodes,
wherein the base mount is constituted of a plurality of base mounts, and
the laser diodes are respectively mounted on the plurality of base mounts.

9. The optical element assembly according to claim 7,
wherein the optical waveguide substrate is an Si substrate, and
a core of the optical waveguide layer is made of SiO₂.

10. The optical element assembly according to claim 7,
wherein the optical waveguide substrate is an SiO₂ substrate, and
a core of the optical waveguide layer is made of SiN.

11. The optical element assembly according to claim 7,
wherein the optical waveguide substrate is a sapphire substrate, and
a core of the optical waveguide layer is made of LiNbO₃.

12. An optical module comprising:
the optical element assembly according to claim 1; and
a package,
wherein the optical element assembly is accommodated inside the package.

13. An optical engine comprising:
the optical module according to claim 12; and
an optical scanning mirror reflecting light output from the optical module while changing an angle so as to display an image.

14. XR glasses comprising:
the optical engine according to claim 13 mounted thereon.

15. A method for manufacturing an optical element assembly comprising:
a bonding step of bonding a laser diode assembly to an optical waveguide chip,
wherein the laser diode assembly includes a base mount, and a laser diode mounted on a main surface of the base mount,
the optical waveguide chip includes an optical waveguide substrate, and an optical waveguide layer provided on a main surface of the optical waveguide substrate and having an alignment marker,
the alignment marker is provided on an outermost surface of the optical waveguide layer and is positioned on an inner side of an outer peripheral edge of the optical waveguide layer, and
in the bonding step, the optical waveguide layer is observed in a plan view to identify an input port of a core of the optical waveguide layer and positionally align the laser diode assembly using coordinates of the alignment marker, and the laser diode assembly is bonded to the optical waveguide chip in a state where the laser diode assembly is positionally aligned.

16. The method for manufacturing an optical element assembly according to claim 15,
wherein the laser diode assembly is positionally aligned such that a center of the input port of the core of the optical waveguide layer coincides with an optical axis of laser light output from the laser diode.

17. The method for manufacturing an optical element assembly according to claim 15,
wherein after positional alignment using the coordinates of the alignment marker, laser light is irradiated from the laser diode, and a position of the laser diode assembly is finely adjusted while checking an intensity of the laser light from an output port of the optical waveguide layer.

18. The method for manufacturing an optical element assembly according to claim 15, further comprising:
a dicing step and an alignment marker forming step prior to the bonding step,
wherein in the dicing step, a plurality of the optical waveguide chips are formed by dicing a substrate provided with a plurality of the optical waveguide layers, and
in the alignment marker forming step, an alignment marker is formed on the optical waveguide layer of each of the plurality of the optical waveguide chips.

19. The method for manufacturing an optical element assembly according to claim 15, further comprising:
a bar cutting-out step and an alignment marker forming step prior to the bonding step; and
a dicing step after the bonding step,
wherein in the bar cutting-out step, an optical waveguide bar member including a plurality of the optical waveguide chips is cut out from a substrate provided with a plurality of the optical waveguide layers,
in the alignment marker forming step, an alignment marker is formed on each of one or more of the optical waveguide layers of the optical waveguide bar member,
in the bonding step, the optical waveguide layers are observed in a plan view to identify any one input port of the optical waveguide layers and positionally align the laser diode assembly using coordinates of the alignment marker, the laser diode assembly is bonded to the optical waveguide bar member in a state where the laser diode assembly is positionally aligned, and this operation is performed for all of the plurality of the optical waveguide layers, and
in the dicing step, the optical waveguide bar member including a plurality of the laser diode assemblies bonded thereto is diced.

20. The method for manufacturing an optical element assembly according to claim 18,
wherein in the alignment marker forming step, a thin film made of gold or tantalum is formed on the optical waveguide layer.
